(19) United States
(12) Patent Application Publication
(10) Pub. No.: US 2013/0248317 A1
(43) Pub. Date: Sep. 26, 2013

(54) ALL WHEEL DRIVE DISCONNECT CLUTCH

(71) Applicant: SCHAEFFLER TECHNOLOGIES AG & CO. KG, Herzogenaurach (DE)

(72) Inventor: Brian Lee, York, SC (US)

(73) Assignee: Schaeffler Technologies AG & Co. KG, Herzogenaurach (DE)

(21) Appl. No.: 13/849,142

(22) Filed: Mar. 22, 2013

Related U.S. Application Data
(60) Provisional application No. 61/615,655, filed on Mar. 26, 2012.

(51) Int. Cl. F16D 13/40

(52) U.S. Cl. CPC F16D 13/40
USPC 192/70.11

(57) ABSTRACT

A drive disconnect clutch assembly, including: an input component arranged to receive torque from a motor; an output gear; and a clutch. The clutch includes: a piston plate; at least one clutch plate; at least one wedge plate; and respective friction material disposed between the at least one clutch plate and the at least one wedge plate. The piston plate is arranged to: displace a first distance in a first axial direction to clamp the at least one clutch plate and the at least one wedge plate to lock rotation of the input component to rotation of the output gear; and displace further in the first axial direction to displace the at least one wedge plate to lock respective rotations of the input component and the output gear via contact of the at least one wedge plate with the input component and the output gear.

### CROSS-REFERENCE TO RELATED APPLICATIONS

This application claims the benefit under 35 U.S.C. §119(e) of U.S. Provisional Patent Application No. 61/615,655 filed Mar. 26, 2012, which application is incorporated herein by reference in its entirety.

### TECHNICAL FIELD

The present disclosure relates a drive disconnect clutch for providing torque to a secondary drive shaft in an all-wheel drive vehicle, specifically, a drive disconnect clutch providing synchronization with frictional engagement of clutch plates and a locked connection with expanding wedge plates.

### BACKGROUND

For providing torque to a secondary drive shaft of an all-wheel drive vehicle, U.S. Pat. No. 7,150,694 is an example of using a clutch in a power transfer unit (PTU), which adds to the mass and size of the PTU. U.S. Pat. No. 7,150,694 and U.S. Pat. No. 7,309,301 are examples of using a transfer (typically wet) clutch in a differential to control torque to a secondary drive shaft. Pressurized fluid must be continuously supplied to keep the clutches in a closed mode, adding to the power usage associated with usage of the clutches. U.S. Pat. No. 6,520,885 is an example of using a roller or dog clutch to control torque to a secondary drive shaft. However, a vehicle must be at a stand still to use of such clutches.

### SUMMARY

According to aspects illustrated herein, there is provided a drive disconnect clutch assembly, including: an input component arranged to receive torque from a motor; an output gear; and a clutch. The clutch includes: a piston plate; at least one clutch plate; at least one wedge plate; and respective friction material disposed between the at least one clutch plate and the at least one wedge plate. The piston plate is arranged to: displace a first distance in a first axial direction to clamp the at least one clutch plate and the at least one wedge plate to lock rotation of the input component to rotation of the output gear; and displace further in the first axial direction to displace the at least one wedge plate to lock respective rotations of the input component and the output gear via contact of the at least one wedge plate with the input component and the output gear.

According to aspects illustrated herein, there is provided a drive disconnect clutch, including: an input component arranged for driving connection to a motor; an output gear; and a clutch. The clutch includes: a piston plate; at least one clutch plate; at least one wedge plate; and respective friction material disposed between the at least one clutch plate and the at least one wedge plate. In a synchronizing mode, the at least one wedge plate is rotationally connected to the input component and the at least one wedge plate is rotatable with respect to the output gear. In the synchronizing mode, the piston plate is arranged to displace a first distance in a first axial direction to clamp the at least one clutch plate and the at least one wedge plate to lock rotation of the input component to rotation of the output gear. In a locked mode, the piston plate is arranged to displace further in the first axial direction such that: the at least one wedge plate is rotated with respect to the input component; and the at least one wedge plate is compressively engaged with the input component and the output gear to lock rotation of the input component to rotation of the output gear.

According to aspects illustrated herein, there is provided a drive disconnect clutch, including: an input component arranged to receive torque from a motor and including an outer circumference formed by a first plurality of flat sides; an output gear; and a clutch including: a piston plate; at least one clutch plate; at least one wedge plate including an inner circumference formed by a second plurality of flat sides in contact with the first plurality of flat sides; a key plate including a plurality of radially displaceable keys; and respective friction material disposed between the at least one clutch plate and the at least one wedge plate. While the plurality of radially displaceable keys rotationally locks the at least one wedge plate and the input component, the piston plate is arranged to displace a first distance in a first axial direction to clamp the at least one clutch plate and the wedge plate to lock rotation of the input component to rotation of the output gear. The piston plate is arranged to displace further in the first axial direction such that: the plurality of radially displaceable keys retract to enable rotation of the at least one wedge plate with respect to the input component; the first plurality of flat sides slide along the second plurality of flat sides; an inner circumference of the wedge plate is in compressive engagement with the input component; and an outer circumference of the wedge plate is in compressive engagement with the output gear.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application; and,

FIG. 2 is a schematic representation of a vehicle with a drive disconnect clutch assembly in a differential assembly;

FIG. 3 is a cross-sectional view of a drive disconnect clutch assembly in a differential assembly;

FIG. 4 is a detail of the drive disconnect clutch assembly in FIG. 3 in a disengaged mode;

FIG. 5 is a detail of the drive disconnect clutch assembly in FIG. 3 in a synchronizing mode;

FIG. 6 is a sectional view generally along line 6-6 in FIG. 5;

FIG. 7 is a detail of the drive disconnect clutch assembly in FIG. 3 in a locked mode; and,

FIG. 8 is a sectional view generally along line 8-8 in FIG. 7.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

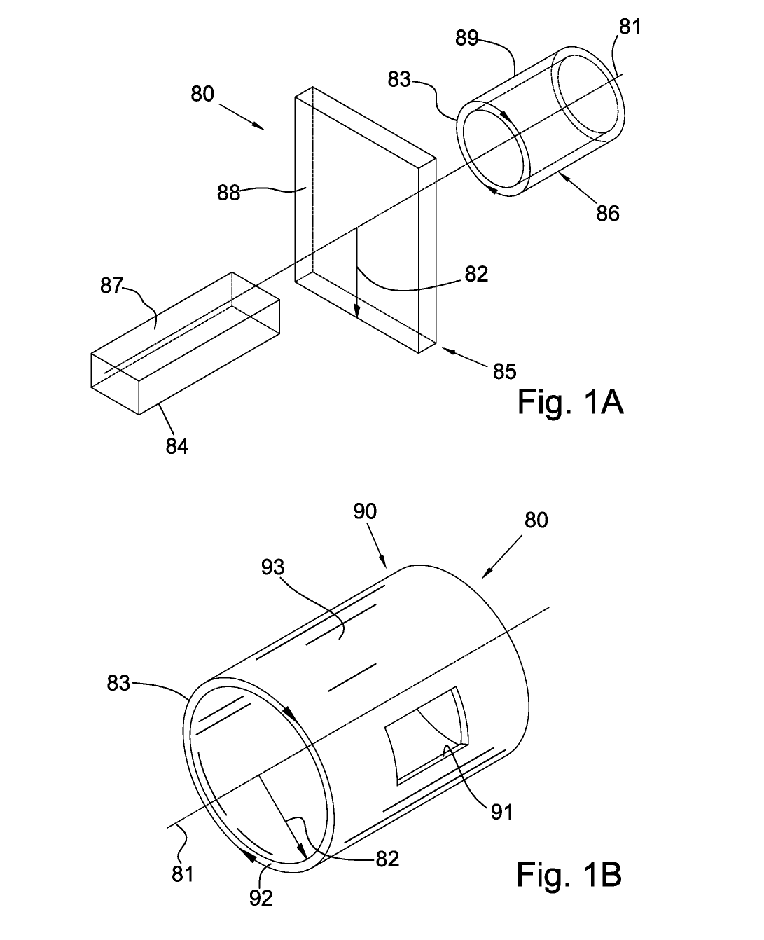

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is a circumferential surface.

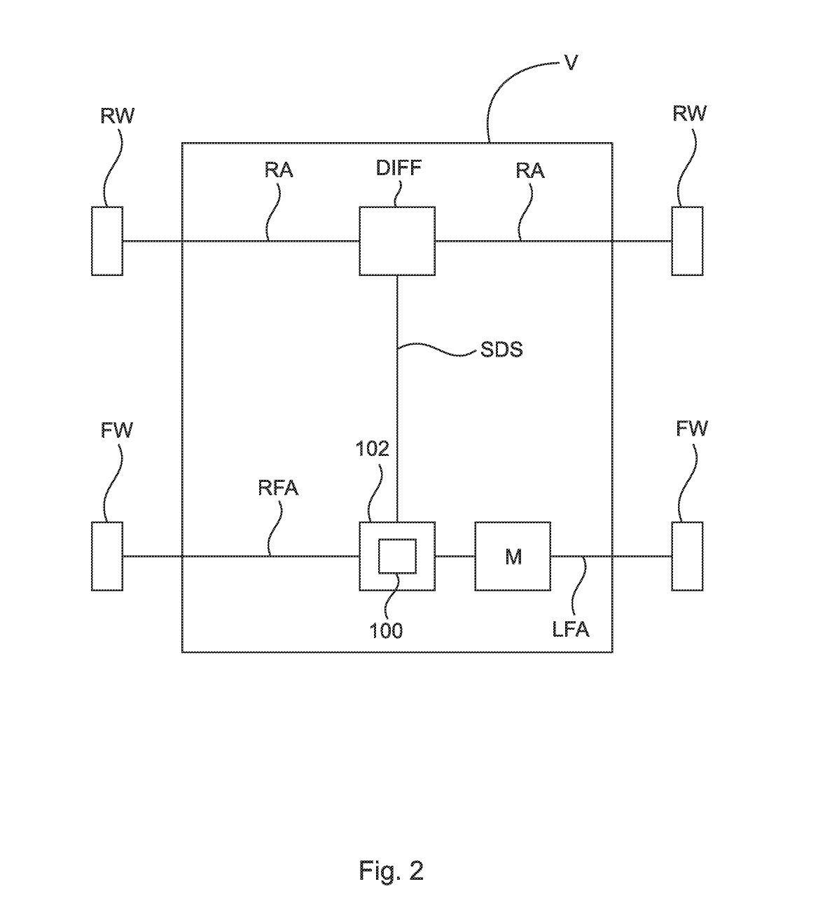

FIG. 2 is a schematic representation of a vehicle with drive disconnect clutch assembly 100 in differential assembly 102.

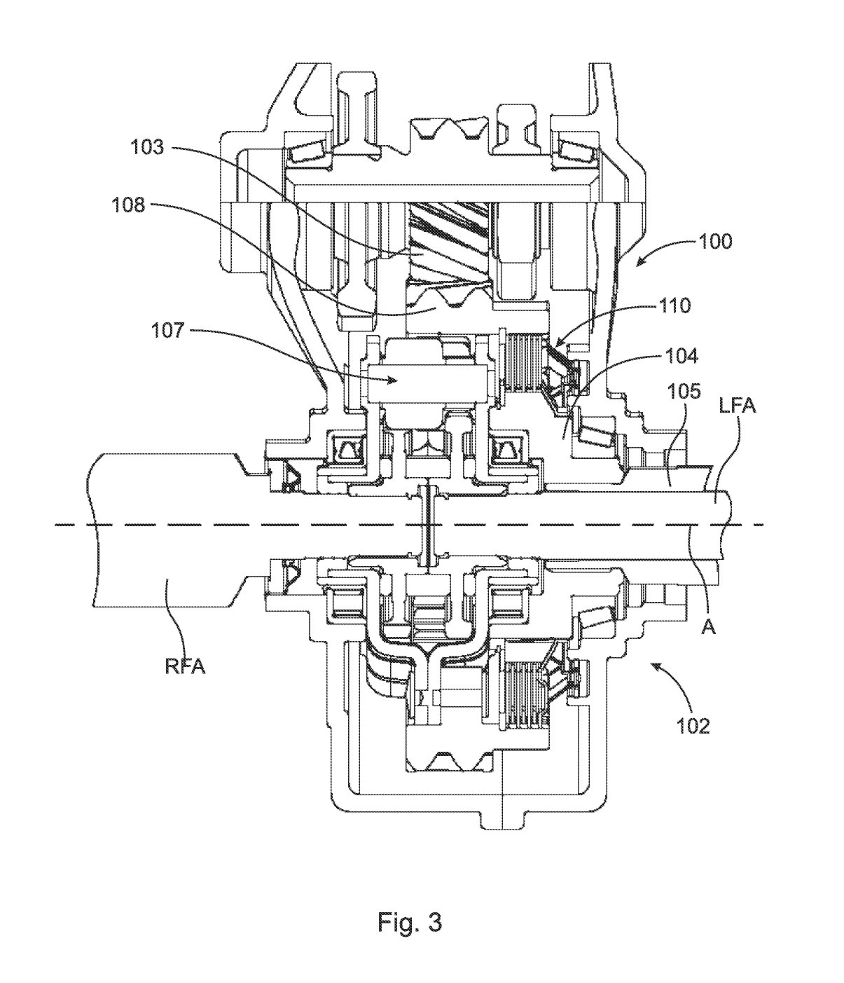

FIG. 3 is a cross-sectional view of drive disconnect clutch assembly 100 in differential assembly 102.

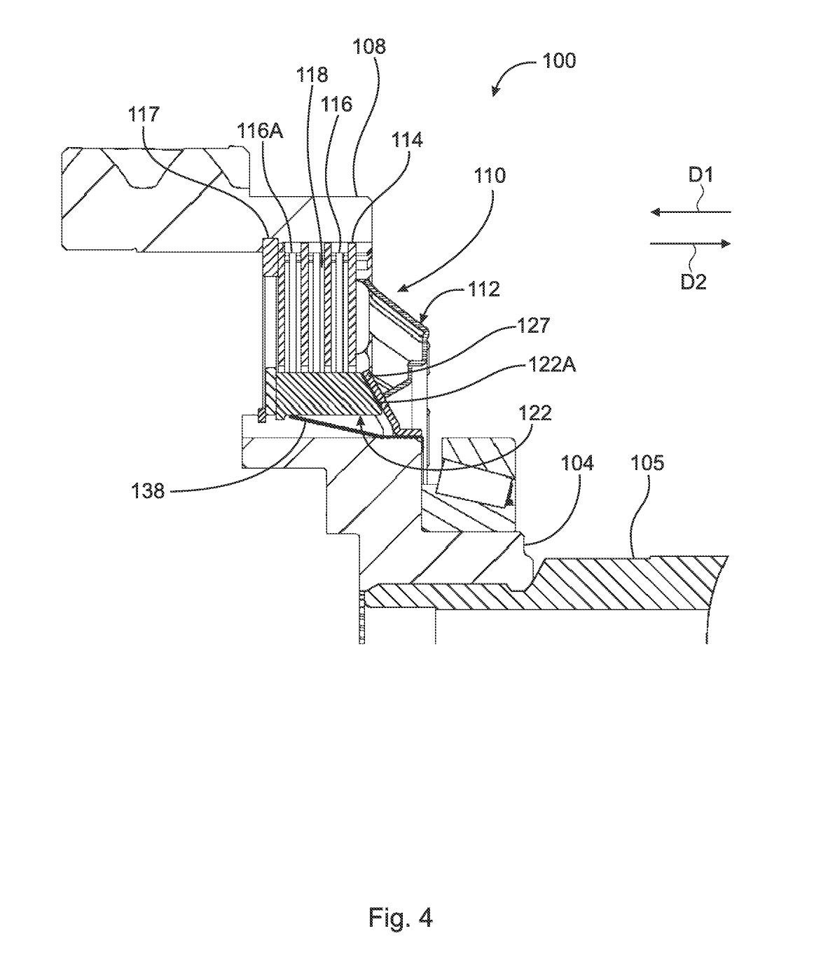

FIG. 4 is a detail of drive disconnect clutch assembly 100 in FIG. 3 in a disengaged mode. The following should be viewed in light of FIGS. 2 through 4. Vehicle V has a standard four-wheel-drive drive vehicle architecture, for example, M is a transverse engine powering the front wheels FW via right front axle RFA, left front axle LFA, and differential assembly 102. Assemblies 100 and 102 are used for connecting and disconnecting a secondary drive shaft SDS, for example, a rear drive shaft, with torque from motor M. Shaft SDS provides torque to rear wheels RW via rear differential assembly DIFF and rear axles RA. Assembly 100 is integrated into differential assembly 102. Thus, as further described below, assembly 100 provides a synchronizing function and a locking clutch to engage and disengage the output/torque of the motor with SDS.

Drive disconnect clutch assembly 100 includes input, or input component (final drive ring gear), 108, arranged to receive torque from the motor, for example via final drive pinion shaft 103, output, or output component, 104, and clutch 110. Output 104 transmits torque to SDS via shaft 105. Gear 108 transmits torque to LFA and RFA via differential gear set 107. Clutch 110 includes piston plate 112, at least one clutch plate 114, at least one wedge plate 116, backing plate 117, and respective friction material 118 disposed between the at least one clutch plate and the at least one wedge plate. In an example embodiment, the friction material is fixed to the at least one wedge plate, but in other embodiments (not shown), the friction material may be fixed to the at least one clutch plate. In the example illustrated by the figures, assembly 100 includes three plates 114 and three plates 116; however, it should be understood that assembly 100 is not limited to a particular number of plates 114 or plates 116 or a particular ratio of plates 114 to plates 116. To simplify the presentation, the discussion that follows is directed to “plates 114,” “clutch plates,” “plates 116,” and “wedge plates”; however, it should be understood that the discussion is applicable to configurations including only one clutch plate or wedge plate, or only one each clutch plate and wedge plate.

As for a typical wet clutch arrangement, clutch plates 114 are keyed to the input such that the clutch plates are axially displaceable and rotationally connected to the input. By “rotationally connected” we mean that two or more components are directly or indirectly connected such that respective rotations of the components are locked. That is, the components rotate in unison. Slots 137 are used to key, or spline, the clutch plates to the input.

In the disengaged mode, the piston plate is positioned such that the piston plate does not clamp the clutch plates and the wedge plates. Further, as described below, the wedge plates are rotationally locked with the output component. Thus, the clutch plates and the input are rotatable with respect to the wedge plates and the output component and torque is not transmitted from the input to the output.

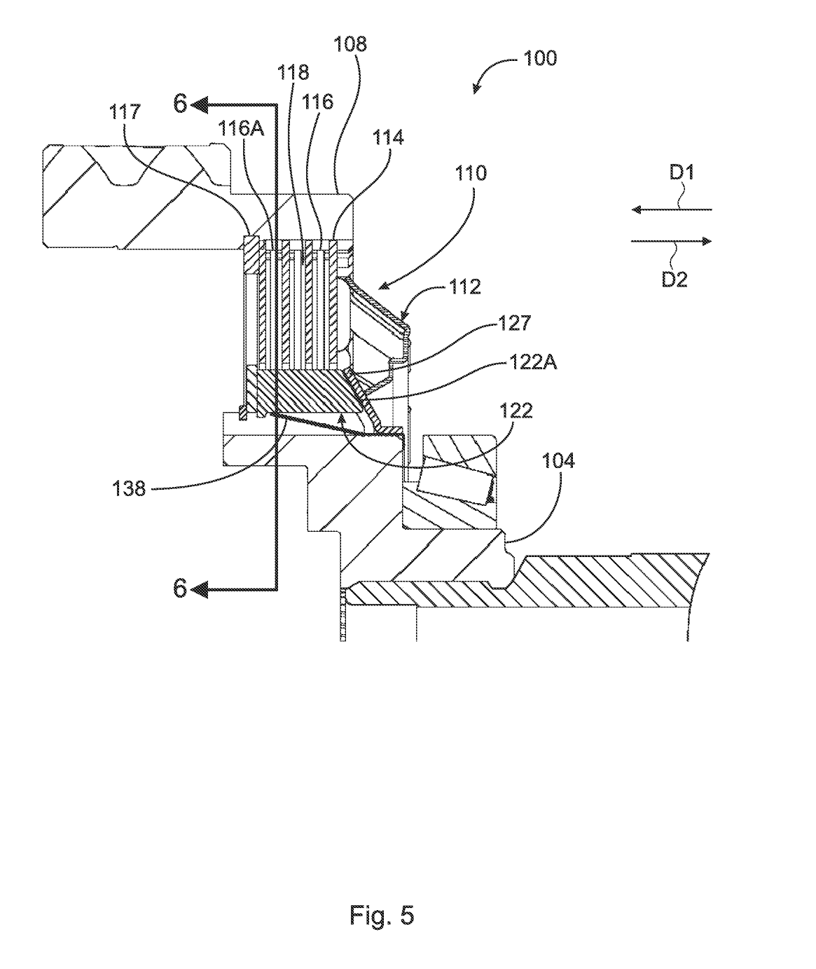

FIG. 5 is a detail of drive disconnect clutch assembly 100 in FIG. 3 in a synchronized mode. The following should be viewed in light of FIGS. 2 through 5. As further described infra, in a synchronizing mode, the wedge plates remain rotationally connected to the output component and the piston plate is arranged to displace in axial direction D1 to clamp the clutch plates and the wedge plates to the backing plate to lock rotation of the input component to rotation of the output.

The clamping of the clutch plates and wedge plates enables torque from the motor and input component to be transmitted to the output, for example, as further described infra, to synchronize energy, or rotational speeds, of the input component and the output component, as well as other components connected to the output component, such as shaft 105 and secondary drive shaft SDS.

As further described infra, in a locked mode, following the synchronizing mode, the piston plate is arranged to displace further in direction D1 to displace the wedge plate keys to lock rotation of the wedge plates with rotation of the input component and the output. Specifically, the wedge plates are expanded and wedged between the input component and the output. Once the wedge plates are displaced to lock the rotation of the input component and the output, torque can be transferred from the input component to the output via the wedge plates. Thus, the clutch plates are no longer needed for torque transfer, and as further described infra, the piston can be displaced in direction D2, opposite D1, to relieve axial pressure on the clutch plates and enable the clutch plates to disengage from the wedge plates. Advantageously, the amount of force applied to the piston, for example, in the form of pressurized hydraulic fluid, during closed operation of the clutch (to maintain torque transfer from the input component to the output gear) is reduced. For example, rather than applying an amount of force needed to radially retract the wedge keys and clamp the wedge plates and clutch plates, only the lesser amount of force needed to retract the wedge keys is applied to the piston.

Clutch 110 includes key plate 122 rotationally connected to the output component. During the disengaged mode and the displacement of the piston in the synchronizing mode, the key plate is engaged with the wedge plates to rotationally lock the wedge plates and the output component. During the locked mode, the piston plate is arranged to displace the key plate to enable relative rotation between the wedge plates and the output component such that the wedge plates contact the input. This contact rotationally locks the wedge plates, the input component, and the output, enabling torque transmission from the input component to the output by the wedge plates without the use of the clutch plates.

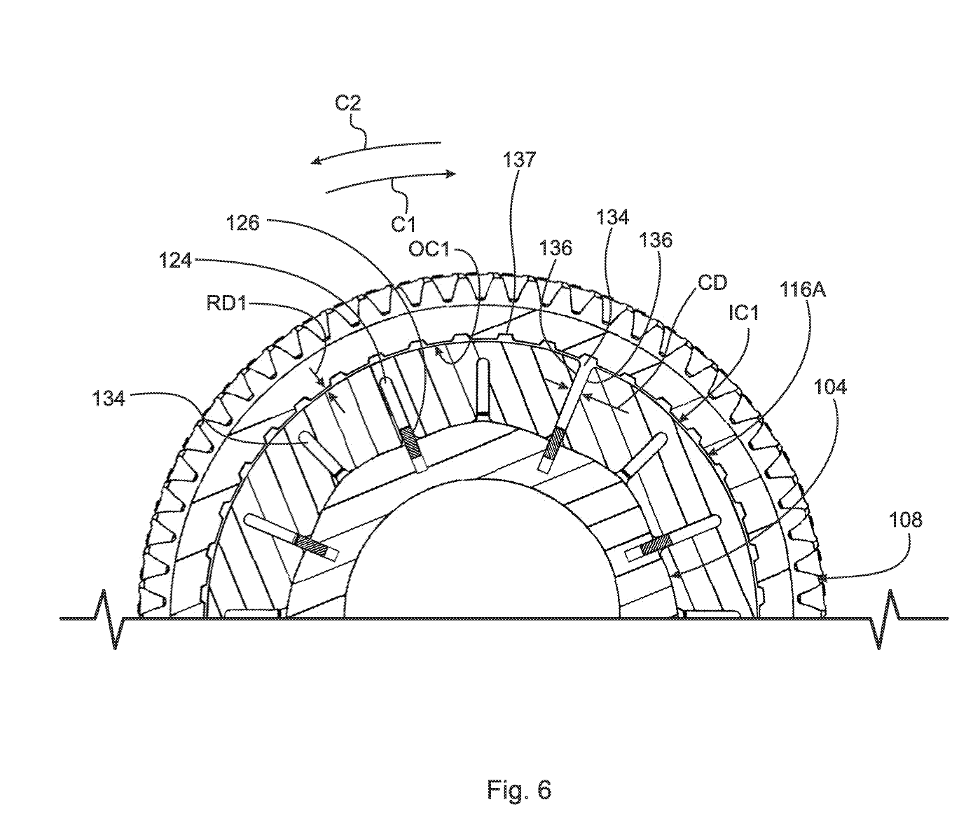

FIG. 6 is a sectional view generally along line 6-6 in FIG. 5 with assembly 100 in the synchronizing mode. The following should be viewed in light of FIGS. 2 through 6. In FIG. 6, single wedge plate 116A is shown; however, it should be understood that the discussion is applicable to the remaining wedge plates. In an example embodiment, each wedge plate includes respective slots 124 and the key plate includes keys 126 arranged to be disposed within slots 124 during the disengaged and synchronizing modes. The keys, like the key plate, are rotationally connected to the output component; therefore, the keys rotationally connect the wedge plates and the output component while disposed in the slots.

In the synchronizing mode, the wedge plates are rotatable with respect to the input, that is, respective outer circumferences OC1 of the wedge plates and inner circumference IC1 of the input are separated by radial distance RD1.

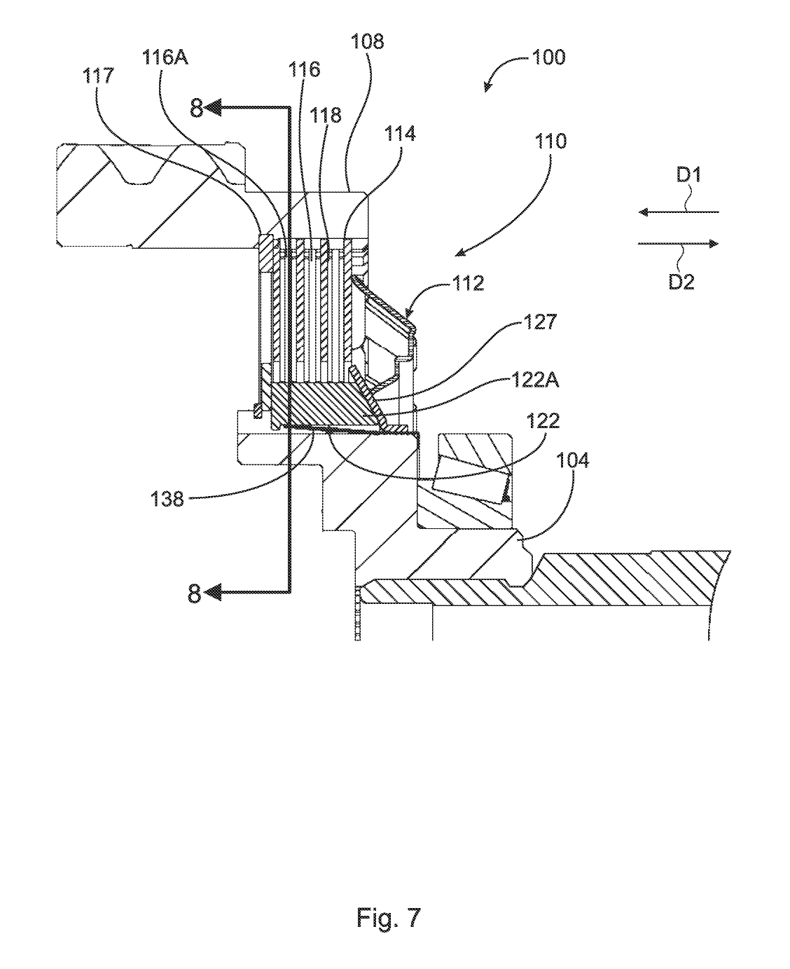

FIG. 7 is a detail of drive disconnect clutch assembly 100 in FIG. 3 in a locked mode.

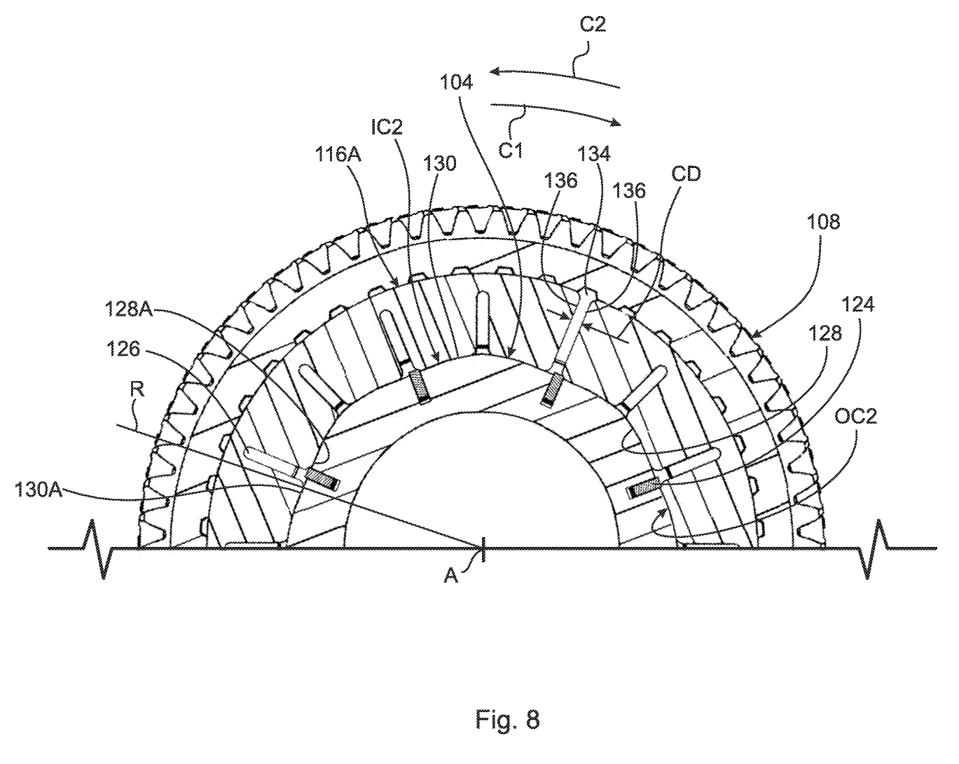

FIG. 8 is a sectional view generally along line 8-8 in FIG. 7. The following should be viewed in light of FIGS. 2 through 8. In the locked mode, the piston plate is arranged to engage the wedge plate key to displace the plurality of keys radially inward such that the plurality of keys are disengaged from the plurality of slots, and the wedge plates are rotatable to compressively engage the input component and the output to lock respective rotations of the input component and the output. For example, piston element 127, engaged with the piston and portion 122A of the wedge plate key are mutually angled such that as 127 urges 122A in direction D1, 122A is displaced radially inward, drawing the keys out of slots 124.

In an example embodiment, the output component includes outer circumference OC2 with flat surfaces 128 and the wedge plate includes inner circumference IC2 with flat surfaces 130. Pairs of mated surfaces 128 and 130, for example 128A and 130A, are at an acute angle with respect to a radius R passing through the surfaces. That is the surfaces form complementary ramps with respect to circumferential directions C1 and C2. In the disengaged and synchronizing modes, surfaces 128 and 130 are engaged such that plates 116 are in maximally radially inward positions (distance RD1 is present).

In the locked mode, as further described infra, enabling the wedge plates to rotate with respect to the output component, for example, withdrawing the keys from the slots, causes the wedge plates to compressively engage the input component and the output (distance RD1 is removed) to lock respective rotations of the input component and the output.

In the locked mode, the wedge plates are no longer fixed by keys 126 and the wedge plates rotate with respect to the output component, for example, in direction C1, due to contact with the clutch plates. Respective surfaces 128 then slide along respective surfaces 130. That is, the frictional engagement of the wedge plates with the clutch plates urges the wedge plates in direction C1. Due to the ramp configuration described above, as surfaces 128 slide along surfaces 130, surfaces 128 are pushed radially outward, pushing 1C2 of the wedge plates radially outward. In turn, as further described infra, OC1 also expands radially outward. It should be understood that movement of the wedge plates in direction C2, opposite C1, from the synchronizing position results in the same radially outward displacement of the wedge plates described above.

Thus the wedge plates are in compressive engagement with the input component and the output to rotationally lock the input component and the output component and to transmit torque from the input component to the output. By “compressive engagement,” we mean that the wedge plates exert a pressure, for example in a radial direction, on the input component and/or the output, or the input component and the output exert a pressure, for example in a radial direction, on the wedge plates. In an example embodiment, the rotation of the wedge plates with respect to the output component is typically small, for example, two or three degrees. However, it should be understood that other amounts of relative rotation between the wedge plates and the output component are possible.

In an example embodiment, the wedge plates are discontinuous in the circumferential directions by virtue of a radially disposed space 135 separating circumferential ends 136 of the wedge plate by circumferential distance CD. In the locked mode, the piston plate, via the output component, element 127, and plate 122, is arranged to increase CD to expand the wedge plate radially outward. That is, space 135 enables the wedge plate to expand radially outward in response to rotation of the output and the sliding contact of surfaces 128 and 130 to contact the input.

Advantageously, once the wedge plates are radially expanded to compressively engage the input component and the output, that is, the wedge plates are wedged between the input component and the output, the wedge plates are able to transmit torque and the clutch plates are no longer needed to transmit torque. Therefore, the force on the piston, for example, pressurized hydraulic fluid, can be reduced as described above. Thus, the energy requirement of assembly 100 is reduced, since it is no longer necessary to provide pressurized fluid to clamp the clutch plates. As long as torque is being transmitted from the input component to the wedge plates in direction C1, the wedge plates remain locked to the input component and the output.

As noted above, the wedge plates remain engaged with input component and the output component as long as torque from the motor is present on the input component (drive mode). In a coast mode, torque from the motor is withdrawn from the input component (for example, an accelerator for the motor is released) and the wheels associated with axle SA are rotating and applying torque to shaft 105. The torque from the axle causes the output to rotate in direction C2, which in turn, causes the wedge plates to rotate in direction C2 with respect to the input component. As noted above, as long as the keys are withdrawn by the piston, rotation in direction C2 also causes the wedge plates to radially expand and lock the input component with the output gear. That is, as the surfaces slide toward the position associated with the synchronizing mode (keys aligned with slots 124) the wedge plates radially contract, but as the surfaces slide past the position, the surfaces cause the wedge plates to again expand. Thus, as long as the keys remain retracted, the wedge plates continue to transmit torque in alternating drive and coast modes without the need for clamping the wedge plates.

In an example embodiment, clutch 110 includes resilient element 138 engaged with keys 126 and urging keys 126 radially outward, for example, urging the keys into slots 124 during the disengaged and synchronizing modes. For example, when the piston plate displaces in direction D1 against the wedge plate key, the action of the piston plate displaces the keys radially inward against the force of the resilient element to enable rotation of the wedge plates with respect to the output component. If the piston is retracted such that the piston no longer urges the keys radially inward, element 138 urges the keys radially outward. In the locked mode, the keys are urged against surfaces 128, but cannot enter slots 124 due to the misalignment of the keys and slots 124.

To disengage the clutch (disengaged mode), the piston is withdrawn and the keys contact surfaces 128 as described above. Then, when a transition from torque in direction C1 to torque in direction C2 occurs (or vice versa) and the wedge plates circumferentially shift, slots 126 align with the keys and element 138 pushes the keys into slots 126, locked the output component and the wedge plates. The re-alignment of slots 126 and the keys enables OC1 to contract radially inward so that distance RD1 is again formed, as described above. Therefore, the wedge plate rotates with the output component, the wedge plate rotates independently of the input, and the clutch plates are unclamped. Thus, no torque is transmitted through assembly 100.

Advantageously, assembly 100 does not increase the size of a state-of-the-art bevel gear differential assembly with a disconnect clutch such as clutch 110.

Clutch 110 synchronizes the energy of stationary components during initial clutch lock up, for example in the synchronizing mode. For example, when clutch 100 is disengaged, torque from the motor is not supplied to the “downstream” components such as the output, shaft 105, and shaft SDS and these components are at rest. Thus, as described supra, to begin clutch 110 lockup, an axial force is applied by the piston plate forcing the respective friction material into contact with clutch plates 114 on opposite axial sides of the wedge plates. The axial friction force functions in clutch 110, for example, as for a typical automatic transmission wet clutch until the entire driveline (including down stream components) has reached a synchronized speed, or a point near the synchronized speed such that noise, vibration, harshness (NVH) is satisfactory. Thus, in the synchronizing mode described supra, clamping the clutch plates and wedge plates in clutch 110 transmits torque from the motor such that the downstream components are brought from rest positions to respective rotational speeds synchronized with the input to assembly 100.

In the locked mode described supra, when the driveline has reached the synchronized speed, or the point near the synchronized speed, clutch 110, via the compressive engagement of the wedge plates with the input component and the output, transmits full driveline torque requirements to the secondary drive shaft. Thus, an abrupt transfer of torque, with an associated and undesirable jolt is avoided by first synchronizing the driveline and then engaging the wedge plates.

Although a particular configuration of clutch plates and wedge plates is shown, it should be understood that assembly 100 is not limited to the configuration shown. Other numbers of clutch plates or wedge plates are possible in order to satisfy surface area requirements for torque transfer.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What I claim is:

1. A drive disconnect clutch assembly, comprising:
an input component arranged to receive torque from a motor;
an output gear; and,
a clutch including:
a piston plate;
at least one clutch plate;
at least one wedge plate; and,
respective friction material disposed between the at least one clutch plate and the at least one wedge plate, wherein the piston plate is arranged to:
displace a first distance in a first axial distance to clamp the at least one clutch plate and the at least one wedge plate to lock rotation of the input component to rotation of the output gear; and,
further displace in the first axial direction to displace the at least one wedge plate to lock respective rotations of the input component and the output gear via contact of the at least one wedge plate with the input component and the output gear.

2. The drive disconnect clutch assembly of claim 1, wherein:
in a disengaged mode, the at least one wedge plate is rotationally connected with the output gear and the input component is independently rotatable with respect to the output gear; and,
during the displacement of the piston by the first distance, the at least one wedge plate shifts in a circumferential direction with respect to the input component.

3. The drive disconnect clutch assembly of claim 1, wherein during the displacement of the piston by the first distance, an outer circumference of the at least one wedge plate is free of contact with the output gear.

4. The drive disconnect clutch assembly of claim 1, wherein:
the clutch includes a wedge plate key;
rotation of the wedge plate key is locked to rotation of the input component;
during the displacement of the piston by the first distance, the wedge plate key is engaged with the at least one wedge plate to lock rotation of the at least one wedge plate to rotation of the input component; and,
during the further displacement in the first axial direction, the piston plate is arranged to displace the wedge plate key such that the at least one wedge plate is rotatable with respect to the input component to compressively engage the output gear.

5. The drive disconnect clutch assembly of claim 4, wherein:
the at least one wedge plate includes respective pluralities of slots;
the wedge plate key includes a plurality of keys arranged to be disposed within the respective pluralities of slots during the displacement of the piston in the first axial direction; and,
the piston plate is arranged to further displace in the first axial direction to engage the wedge plate key to displace the plurality of keys radially inward such that:
the plurality of keys are disengaged from the respective pluralities of slots; and,
the at least one wedge plate is rotatable to compressively engage the input component to lock respective rotations of the input component and the output gear.

6. The drive disconnect clutch assembly of claim 1, wherein:
the input component includes an outer circumference with a first plurality of flat surfaces;
the at least one wedge plate includes respective inner circumferences with a second plurality of flat surfaces in contact with the first plurality of flat surfaces; and,
the piston plate is arranged to further displace in the first axial direction such that:
the at least one wedge plate rotates with respect to the input component; and,
the second plurality of flat surfaces slide across the first plurality of flat surfaces to displace the at least one wedge plate radially outward to compressively engage the output gear and lock rotation of the input component to rotation of the output gear.

7. The drive disconnect clutch assembly of claim 1, wherein:
the at least one wedge plate includes respective inner circumferences and each wedge plate is discontinuous in a circumferential direction by virtue of a respective radially disposed space separating respective first and second circumferential ends of the wedge plate by a respective circumferential distance; and,
the piston plate is arranged to further displace in the first axial direction to increase the respective circumferential distances to expand the at least one wedge plate radially outward.

8. The drive disconnect clutch assembly of claim 7, wherein the at least one wedge plate is arranged to expand radially outward to compressively engage the input component and the output gear to lock respective rotations of the input component and the output gear.

9. A drive disconnect clutch, comprising:
an input component arranged for driving connection to a motor;
an output gear; and,
a clutch including:
a piston plate;
at least one clutch plate;
at least one wedge plate; and,
respective friction material disposed between the at least one clutch plate and the at least one wedge plate, wherein:
in an synchronizing mode:
the at least one wedge plate is rotationally connected to the input component and the at least one wedge plate is rotatable with respect to the output gear; and,
the piston plate is arranged to displace a first distance in a first axial direction to clamp the at least one clutch plate and the at least one wedge plate to lock rotation of the input component to rotation of the output gear; and,
in a locked mode, the piston plate is arranged to displace further in the first axial direction such that:
the at least one wedge plate is rotated with respect to the input component; and,
the at least one wedge plate is compressively engaged with the input component and the output gear to lock rotation of the input component to rotation of the output gear.

10. The drive disconnect clutch assembly of claim 11, wherein in a disengaged mode, the at least one wedge plate is rotationally connected with the output gear and the input component is independently rotatable with respect to the output gear.

11. The drive disconnect clutch assembly of claim 9, wherein during the displacement of the piston by the first distance, an outer circumference of the at least one wedge plate is free of contact with the output gear.

12. The drive disconnect clutch assembly of claim 9, wherein:
the clutch includes a wedge plate key with a plurality of radially displaceable keys,
rotation of the wedge plate key is locked to rotation of the input component;
in the synchronizing mode, the plurality of keys engages the at least one wedge plate to rotationally connect the at least one wedge plate with the input component; and,
in the locked mode, the piston plate is arranged to displace the plurality of keys radially inward to enable rotation of the at least one wedge plate with respect to the input component.

13. The drive disconnect clutch assembly of claim 9, wherein:
the input component includes an outer circumference with a first plurality of flat surfaces;
the at least one wedge plate includes respective inner circumferences with a second plurality of flat surfaces in contact with the first plurality of flat surfaces; and,
the piston plate is arranged to further displace in the first axial direction such that:
the at least one wedge plate rotates with respect to the input component; and,
the second plurality of flat surfaces slide across the first plurality of flat surfaces to displace the at least one wedge plate radially outward to compressively engage the output gear and lock rotation of the input component to rotation of the output gear.

14. The drive disconnect clutch assembly of claim 9, wherein:
each wedge plate is discontinuous in a circumferential direction by virtue of a radially disposed space separating respective first and second circumferential ends of the wedge plate by a respective circumferential distance; and,
in the locked mode, the input component is arranged to engage the at least one wedge plate to expand the at least one wedge plate radially outward and increase the respective circumferential distances.

15. The drive disconnect clutch assembly of claim 9, wherein:
in a drive mode for the locked mode, the input component is arranged to rotate in a first rotational direction; and,
in a coast mode for the locked mode, the output gear is arranged to transmit torque to the at least one wedge plate such that the at least one wedge plate rotates in a second rotational direction, opposite the first rotational direction.

16. A drive disconnect clutch, comprising:
an input component arranged to receive torque from a motor and including an outer circumference formed by a first plurality of flat sides;
an output gear; and,
a clutch including:
a piston plate;
at least one clutch plate;
at least one wedge plate including an inner circumference formed by a second plurality of flat sides in contact with the first plurality of flat sides;
a key plate including a plurality of radially displaceable keys; and, respective friction material disposed between the at least one clutch plate and the at least one wedge plate, wherein:
while the plurality of radially displaceable keys rotationally locks the at least one wedge plate and the input component, the piston plate is arranged to displace a first distance in a first axial direction to clamp the at least one clutch plate and the wedge plate to lock rotation of the input component to rotation of the output gear; and,
the piston plate is arranged to displace further in the first axial direction such that:
the plurality of radially displaceable keys retract to enable rotation of the at least one wedge plate with respect to the input component;
the first plurality of flat sides slide along the second plurality of flat sides;
an inner circumference of the wedge plate is in compressive engagement with the input component; and,
an outer circumference of the wedge plate is in compressive engagement with the output gear.

17. The drive disconnect clutch assembly of claim 16, wherein in a disengaged mode, the at least one wedge plate is rotationally connected with the output gear and the input component is independently rotatable with respect to the output gear.

18. The drive disconnect clutch assembly of claim 16, wherein during the displacement of the piston by the first distance, an outer circumference of the at least one wedge plate is free of contact with the output gear.
